(19) United States
(12) Patent Application Publication
(10) Pub. No.: US 2006/0184511 A1
(43) Pub. Date: Aug. 17, 2006

(54) Semantic network document container for use in attestation of management reports

(76) Inventors: Sing Chi Koo, Cupertino, CA (US); Connie Lai Ying Chun, Cupertino, CA (US); Ka-Fung Koo, Cupertino, CA (US)

Correspondence Address: Sing Chi Koo, 10139 Mello Place, Cupertino, CA, 95014, US

(21) Appl. No.: 11/059,046

(22) Filed: Feb. 16, 2005

(51) Int. Cl. G06F 17/30

(52) U.S. Cl. 707/3

(57) ABSTRACT

A system that manages semantic network is a medium for objective framework and document repository. An integrated dashboard enables the user to maintain a semantic network as a repository for complex document storage and retrieval. The context of this semantic network offers a foundation for document attestation of complex management reports.

### BACKGROUND

1. Field of Invention

This invention relates to the method and procedure of using a semantic network to store and retrieve documents for the purpose documenting facts that attest management reports of business entities.

2. Discussion of Prior Art

Management report of a public corporation is the basis for investors to assess risk and return on investment. This is especially true when it comes to financial reporting. Corporate frauds uncovered in recent years prompted congress to act. Sarbanes Oxley Act became law in June 2002. This legislation affects all publicly traded companies in the way how financial reports are prepared and produced. During the past few years, many commercial establishments introduced commercial solutions to help the management of corporations to comply with this Act. These solutions ranges from information technology solutions, document management systems, to tool kits that outlines management to-do list. Due to the short time-span since the introduction of this law, our search is therefore limited to what we can find in the commercial sector. A company by the name of Sarbanes-Oxley Software has created a tool-kit solution called “Sarbanes-Oxley Toolkit”. It emphasizes in the use of checklist and established guidelines for management to follow. Deloitte and Touche published a web page titled “Sarbanes-Oxley Resources”. This resource page introduces several articles, namely, “Under Control”, “Ten Threats to Compliance” and several others. The key concept as introduced by Deloitte and Touche is on the principle of meeting compliance by identifying risk, rewards and pitfalls of management strategy during the implementation of compliance effort. Redwood Software has a software solution called “Sarbanes-Oxley Software”, which is largely a document management system that provides internal controls for information capture and access, segmentation of duties, document alteration protection and document retention. It does not provide a systematic approach for management to define documents in terms of compliance objective, nor does it provide an integrated monitor and control tool for this purpose. Organization such as The Committee of Sponsoring Organizations of the Treadway Commission (COSO), and American Institute of Certified Public Accountants (AICPA) has published Web pages in their Web-sites to discuss about the Sarbanes Oxley compliance requirements, but did not including any implementation detail. We have found no commercial solution or institutional solution regarding Sarbanes Oxley compliance that suggests the use of semantic network as the foundation for documentation requirement.

Semantic network is a classical topic in the field of artificial intelligence research. There are many of such prior art exist, but none of these prior arts applies semantic networks in the area of document management or for use in law compliance in the context as we are using it in the present invention. During 1985, Koo published a paper during the Expert Systems in Government Symposium talking about the use of semantic network in expert systems. The semantic network was used in the context of propositional logic where a semantic network is used to store the expert system rules for the purpose of inference processing. It did not envision the context of the present invention which adapts a semantic network for the purpose of control, storage, and inspection of documents that support the validation of goals and sub-goals in order to meet the compliance requirements. In the U.S. Pat. No. 4,912,648, Tyler used the fact-based expert system to provide solutions to intermediate problems. The use of inference engine in problem solving is one aspect of a semantic network. The current invention uses a semantic network to define a framework. The framework is built according to a law compliance objective. The resulting network is then used to map relevant documents from a large pool of documents. Its use and scope are totally different from the context as that used in expert systems. In the U.S. Pat. No. 6,477,524 B1, Taskiran et al. proposed a method of matching a query for statistical text analysis. It is not a method for organizing the documents being queried. In U.S. Pat. No. 5,905,498, Diament introduced an invention that uses parent node, arc node, and destination node as the elements to construct a semantic network using a computer system. Diament uses arc nodes to connect parent node and destination node. In our current invention, we only have a single type of node for the entire semantic network. Each node contains relations with other nodes and self-descriptive data. While a node can be viewed as a parent or a child by other nodes, the node itself does not carry such attributes.

We draw a distinction from these prior arts, the present invention uses semantic network nodes as containers to store documents that is relevant to the context of each node. The semantic network is made up of network nodes and relations that connect nodes together to create a framework for an object. A semantic network navigation tool enables the user to traverse the semantic network and query documents stored in each node.

### OBJECTS AND ADVANTAGES

Financial reports from public companies forms the basis of investor confidence. If the financial report cannot be trusted, investor will be defrauded. Enforcing the accountability of financial reports takes more than dedication. The Sarbanes Oxley Act Section 404 requires internal control structures to be put in place in order for the chief executives to attest the material facts that comprise the report. The traditional way of using folders and cabinets to store document will make this job almost impossible. Online document repositories offer a better organization for storage and retrieval. Most document repository systems fall short in providing the context of the big picture. Auditing a financial report requires the lookup of thousands of pages of reports. This makes the job very tedious and error prone. An examination of the procedure involved will help to highlight the shortcomings. A financial report of a public company is likely to include many line items and footnotes. The chief executive officer is required to verify the fact behind each line item and foot notes. Transparent reporting also requires the chief executive officer to account for off-balance sheet transactions and activities. Without a system similar to that of the current invention, the procedure is likely to involve:
1. Determine what is the nature of the line item, for example, department and ownership
2. Determine how the line item is computed, i.e., the method used and the source of the data.
3. Lookup each source report that supports the line item
4. Audit each source recursively, until transparency of the line item is obtained

This procedure is time consuming and is prone to error and omission. It is like the old saying, “don't worry about crossing the bridge until one get there.” If the process of validation is defined ahead of time by means of itemized checklists and journals, the procedure may look like this:

1. Look up the validation procedure that is associated with the line item

2. Follow the procedure to locate the required documents

3. Inspect the documents for relevancy using the context of the current line item

It gets a little better when compares with the prior method. There are less elements of surprise since the validation procedure is defined ahead of time. However, there can still be surprises. For example, the document that is required may be missing, or the document requires further detail supporting documents, and those documents cannot be located or determined. In order to audit a chain of documents, one will have to follow the document-trails. Each layer of document may fan out to more than one document. If all document-trails are to be defined ahead of time in a journal, the complexity will become an obstacle in itself. In the present invention, this complexity is managed with a semantic network. The context of a semantic network node identifies the kind of document, and uses “supporting fact” relation to connect with others nodes. Since the semantic network is not limited by the number of nodes and number of relations interconnecting the nodes, even the most complicated organization structure and activity can be defined systematically. Each node in the semantic network is a document container. It is capable of storing from zero to many documents. A semantic network node can exist without document, as in the case of a proposition. The validation procedure is now reduced into:
1. Begin from the financial report node
2. Recursively examine the supporting nodes for documents until adequate clarity is obtained.

The attestation process is simplified when compared with the existing approaches. As much as many reports are generated by computer systems and programs, the ultimate financial report for public consumption is still a document that requires the signoff of the chief executives officers such as the chief executive officer (CEO) and chief financial officer (CFO).

### DRAWING FIGURES

FIG. 1 is a system diagram showing the functional components of a client server arrangement of the semantic network system.

FIG. 2 is a diagram of a semantic network expressed in a multi-link list.

FIG. 3 is a diagram of a semantic network expressed in nodes and relations

FIG. 4 is a diagram of a semantic network showing an embodiment having the objectives on a Sarbanes Oxley Section 404 compliance project

FIG. 5 shows a sub-goal of Sarbanes Oxley Section 404 compliance, namely, Board and audit committee understanding of risk and control, and its corresponding supporting facts, expressed in a semantic network.

FIG. 6 shows a sub-goal of Sarbanes Oxley Section 404 compliance, namely, Financial and disclosure preparation processes, and its corresponding supporting facts, expressed in a semantic network

FIG. 7 An integrated dashboard consists of graphic user interface—dialogue panel for semantic network maintenance (75) and semantic network display panel (76).

### REFERENCE NUMERALS IN DRAWINGS

1 Disk storage
2 Semantic network server manager residing in a server computer
3 Multiple-link list manager
4 Network connection
5 Semantic network client manager residing in a client computer
6 Interactive graphical user interface for add, modify, delete of nodes and relations
7 Document upload and associates to the semantic network node module
8 Semantic network navigational and document retrieval client
9 A semantic network node and relations represented in an linked-list element, CPTR stands for child pointer.
10 A semantic network node and relations represented in a linked-list element, PPTR stands for parent pointer.
11 A semantic network node and relations represented in a linked-list elements.
12-16 Semantic network nodes and relations represented in link-list elements.
17-24 Semantic network nodes.
25-36 Semantic network relations that connects semantic network nodes.
37-47 Semantic network nodes.
48-57 Semantic network relations that connects semantic network nodes.
48-52 Semantic network nodes.
53-56 Semantic network relations that connects semantic network nodes.
57-63 Semantic network nodes.
67-73 Semantic network relations that connects semantic network nodes.
74 Integrated dash board
75 Graphical user interface dialogue panel
76 Graphical user interface semantic network display panel
77 Radio buttons indicating type of nodes
78 Text field for node name entry
79 Parent-node
80 Current-node
81 Child-node
82-83 Semantic network relations that connects semantic network nodes.
84 Add node button
85 Add relation button
86 Update node button
87 Remove relation button
88 Delete node button
89 Search for node button
90 Go to button
91 View document button
92 Associate document button
93 Jot notes button

### SUMMARY

The documents and facts that support the attestation of management reports for companies are tedious and complex. Semantic network nodes are used to represent high level objects in a management report. In one embodiment, this technique is realized by expressing the facts behind the management report as nodes in the semantic network. Nodes are interconnected by means of relations. Each semantic network node contains a storage that stores relations between the node and other nodes, the name of the node, and access information of documents that are related to the node. Accordingly, another apect of the current invention, a method to manage the semantic network, is described. The method offers a client/server architecture, that enables a user to build the semantic network using graphical user interfaces. A topology consists of nodes in the form of eclipse and relations in the form of arcs. Semantic network nodes are added to the system in real time. Nodes can be added or removed accordingly. Documents can be associated to any nodes in the network. The server component dynamically modifies the semantic network to reflect the latest update, making it possible to answer real time monitoring needs.

### DETAILED DESCRIPTION OF PREFERRED EMBODIMENTS

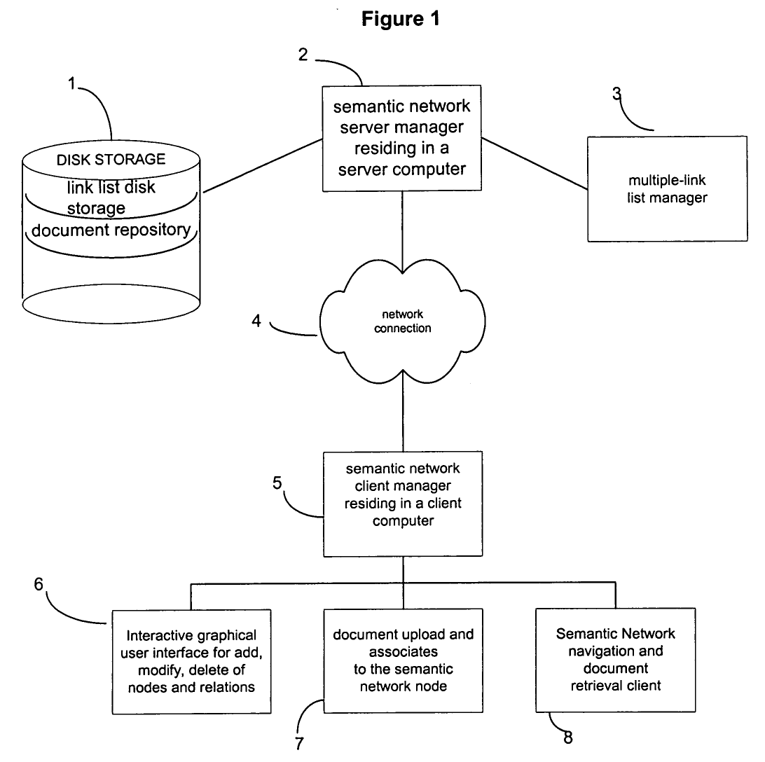

While the present invention relates to the use of a semantic network to store and retrieve documents for the purpose of documenting facts that attest management reports of business entities, it is helpful to review an embodiment of a system in which this invention may be used, as illustrated in FIG. 1. FIG. 1 is a system diagram illustrating a system by which a framework for the purpose of internal control management in an organization can be entered in terms of semantic network nodes and relations. A framework is consisted of network nodes interconnected by means of relations. Each network node has the ability to store information regarding documents that is relevant to that network node.

The semantic network is managed by a semantic network server manager (2). The semantic network server manager uses a multi-link list (3) of objects to implement the semantic network in the computer memory. For the purpose of offline storage and to handle a large number of network nodes, multiple-link list is rolled into a serial format and stored in disk storage (1). The semantic network client manager (5) runs on the client side. A control panel rendered by the semantic network client manager uses graphical user interface (GUI) to receive command from the user. Platforms that supports GUI in popular business environment may include Microsoft's Windows operating system, Unix, Linux, AIX, Solaris. Graphic tools that can be used to implement such control panel may include Microsoft's C++ software developer's toolkit (SDK), Basic SDK, MOTIFF SDK for the X Windows environment, or Java Graphical Libraries.

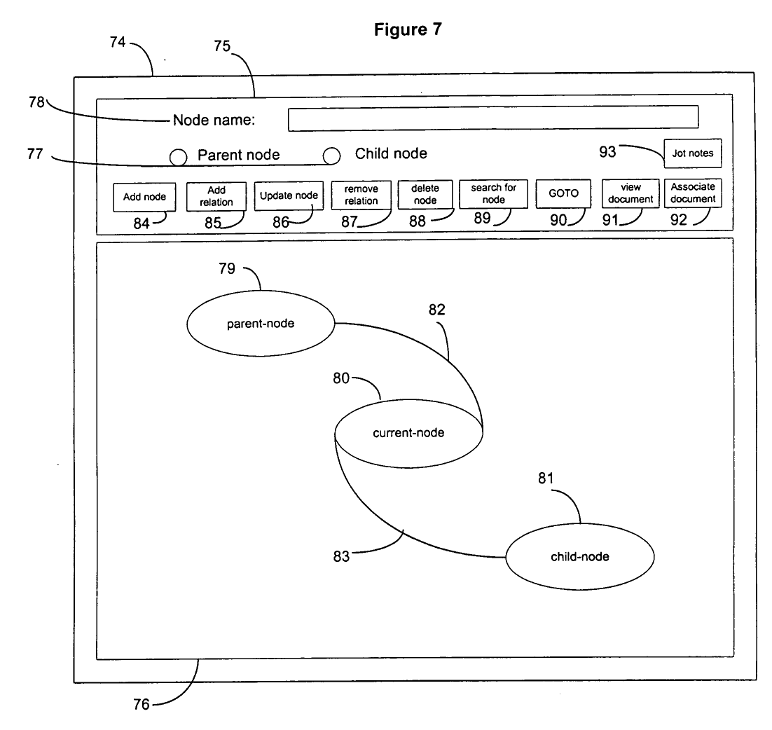

In the present embodiment, an integrated dash board (74) as illustrated in FIG. 7, is consisted of two control panels, namely, dialogue panel for semantic network maintenance (75) and semantic network display panel (76). Through the dialogue panel for semantic network maintenance (75), user can added nodes (84), add relations (85), update nodes (86), remove relations from nodes (86), delete nodes (87), search for a node in the network (88), search for a node (89), and go directly to a node in the semantic network (90), view documents associated to the current-node (91) and associate new documents to the current-node (92) jot notes (93). Relations between nodes are “supported by” and its complement. A parent-node is supported by zero to n child-nodes. FIG. 7 shows a semantic network display panel (76), its relations with other nodes as a parent-node (79) or child-node (81). Users can navigate throughout the entire semantic network by selecting a node as the current node (80), and then click on either a parent-node (79) or child-node (81) to cause an update of the display. As the parent-node or child-node is clicked, a request is sent to the server (2). The server process answers the request by querying the multiple-link list manager (3). The node being clicked will become the current node, with its parent-nodes and child-nodes are returned to the client. The Semantic Network Navigation and Document retrieval Client (8) uses this information to update the display panel (76) to reflect the new current-node (80). While the semantic network is displaying a current node (80), the user can request documents associated with the node to be shown (91). If there are new documents to be added to the current node, it can be associated to the node by the client (92). Documents generated in the normal course of business, or documents generated for the purpose of summarizing the result of audit, inspection or examination are associated to the node where it is relevant. Before document can be added to a node, the node must exist.

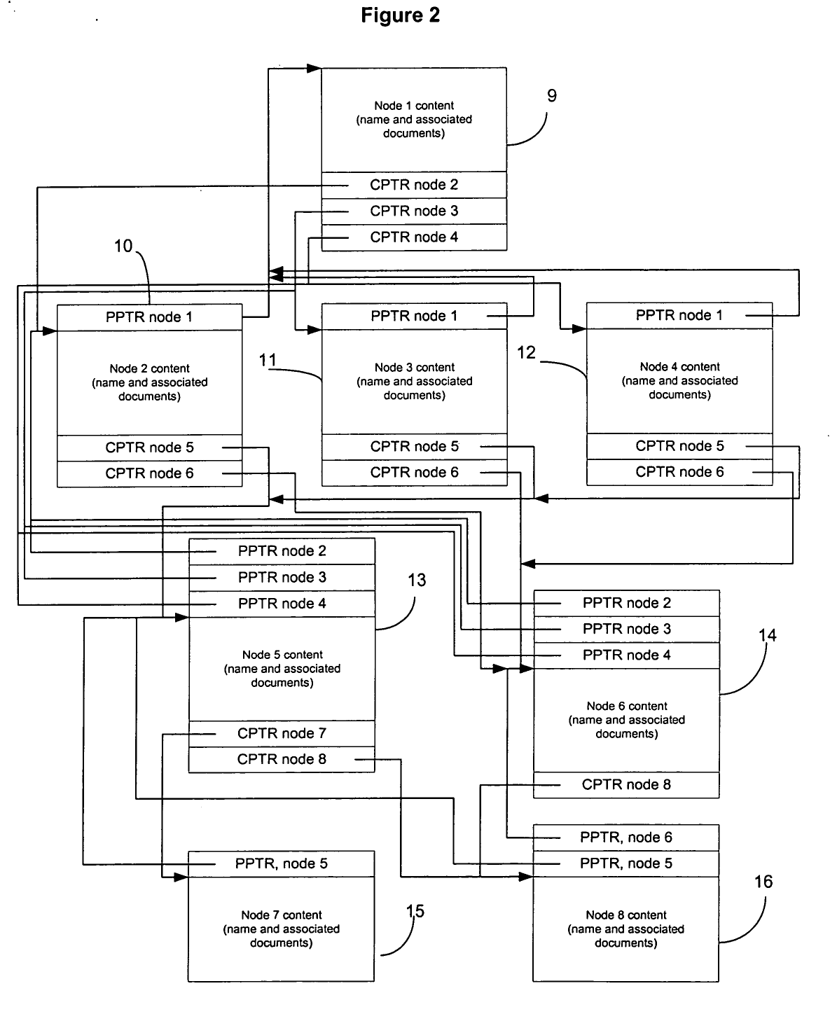

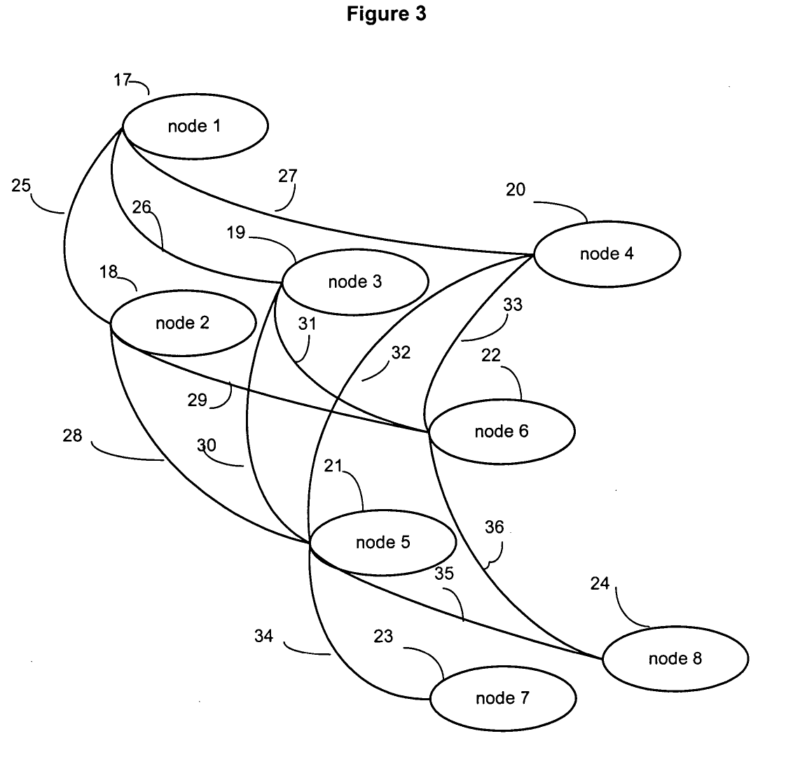

FIG. 2 illustrates a multiple-link list that implements the semantic network for this embodiment. A child-node is denoted by a pointer with the prefix CPTR. A parent-node is denoted by a pointer with the prefix PPTR. Each parent-node to child-node relation is always complemented by a child-node to parent-node relation. The context of a parent-node to child-node relation is “supported by” and the complement is the child-node to parent-node relation having a context of “is a supporting fact of”. The base node (9), namely Node 1 has only child-nodes and no parent-node. The base node has three child-nodes (10,11,12), namely, node2, node3, node 4 respectively. Node 2 (10), Node 3 (11) and Node 4(12) each has a single parent-node which is the base node and two child-nodes, namely, Node 5 (13) and Node 6 (14). Node 5 (13) has two child-nodes, namely, Node 7 (15) and Node 8 (16). Node 6 (14) has one child-node (16). FIG. 3 is the same semantic network as illustrated in FIG. 2, expressed in Arc & Eclipse topology. Each ARC represents the relations “is a supporting fact of” and “is supported by”. The node relatively above is the parent-node and the node relatively below is the child-node.

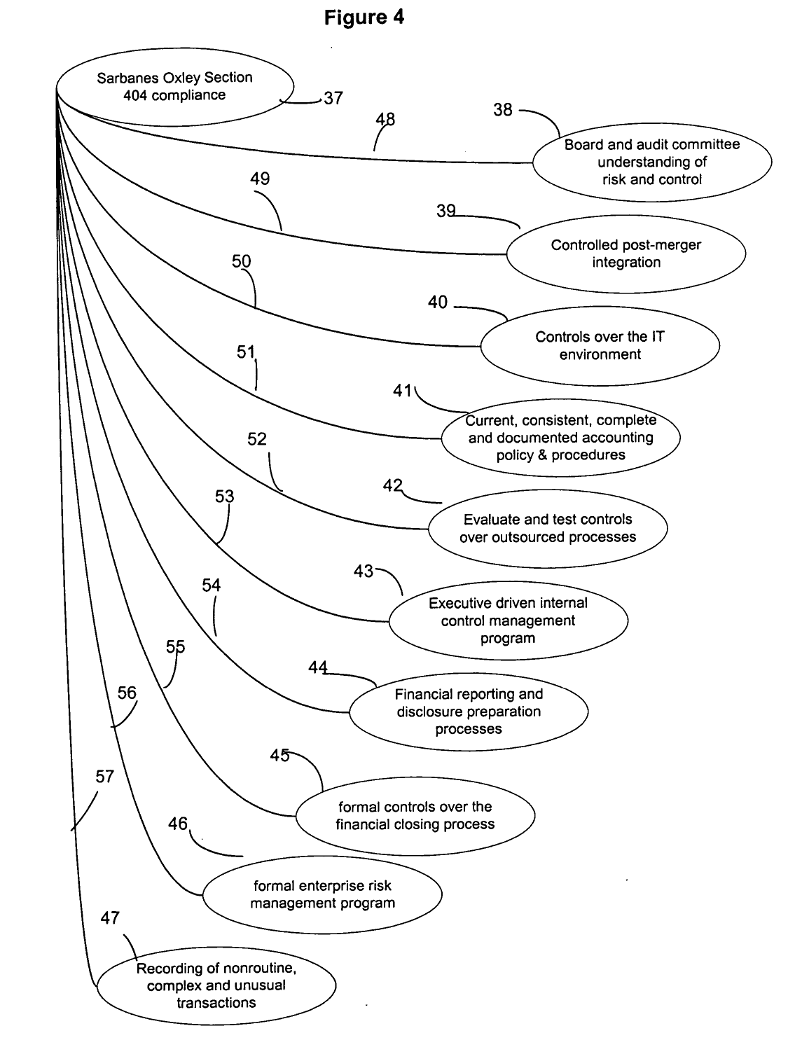

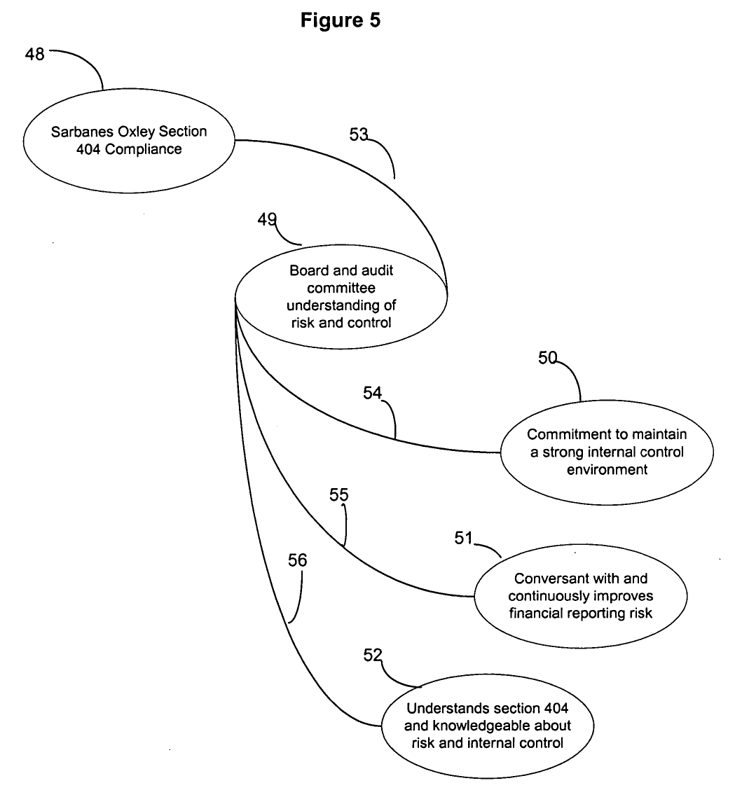

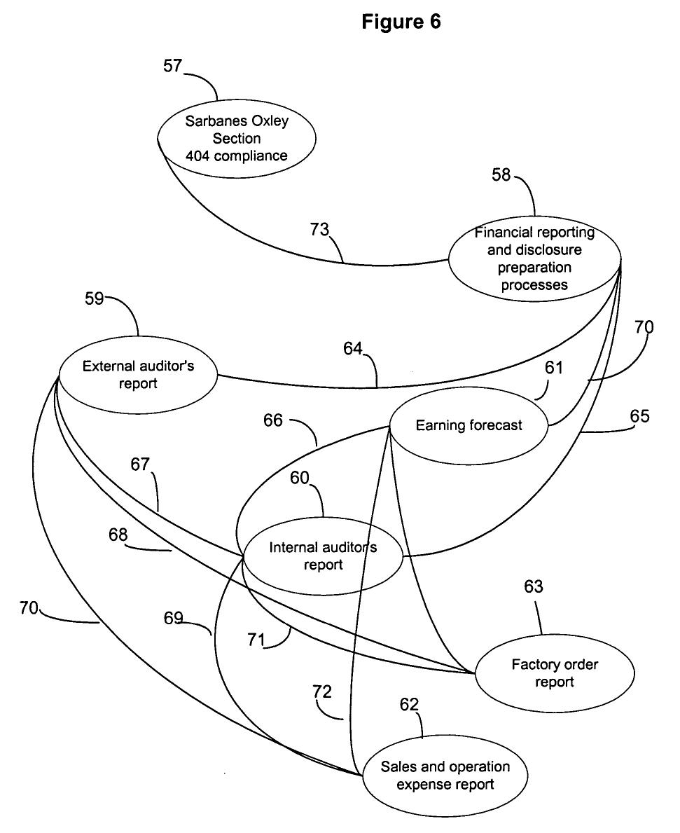

In another embodiment of this invention, a node in the semantic network is used to represent an activity, a process, a policy, or a proposition for the Sarbanes Oxley Section 404 Compliance (37). FIG. 4 depicts a model that supports the requirements set forth by the Sarbanes Oxley Section 404 is expressed in a semantic network. The base node (37) is the objective. It has no parent. Supporting nodes are “Board and audit committee understanding of risk and control” (38), “Controlled post-merger integration” (39), “controls over the IT environment” (40), “Current, consistent, complete and documented accounting policy & procedures” (41), Evaluate and test controls over outsource processes” (42), “Executive driven internal control management program” (43), “Financial reporting and disclosure preparation processes” (44), “Formal control over the financial closing process” (45), “Formal enterprise risk management program” (46), and “Recording of nonroutine complex and unusual transaction” (47). It is apparent that (37) is a proposition, (38) is a policy, (39) is a process, (40) is a policy, (41) is a policy, (42) is a process, (43) is an activity, (44) is a process, (45) is a process, (46) is an activity, (47) is a process. In this embodiment, the context of a semantic node is primary for the benefit of the user who has to grasp the meaning of the node and associate documents to it accordingly. Most of these semantic network nodes require additional details, thus, appropriate child-nodes must be added to elaborate the details. FIG. 5 illustrates a lower level of details with regard to “Board and audit committee understanding of risk and control” (49). The child-nodes are “Commitment to maintain a strong internal control environment” (50), “Conversant with and continuously improves financial reporting risk” (51), and “Understands section 404 and is knowledgeable about risk and internal control”. FIG. 6 illustrates a lower level of details with regard to “Financial reporting and disclosure preparation processes”. The topology of nodes (58,59,60,61,62) brings out another property of the semantic network. (59) is a parent-node of (60) and (62) and (63) as much as (60) is also a parent of (62) and (63). Similarly, (61) is a parent-node of (60), (62), and (63) as much as (60) is also a parent of (62) and (63). This property is a distinction that differentiates semantic network from hierarchical topology. After detail nodes are examined and conclusion is drawn, the corresponding node is update with a summary note to document the result. User can activate the jot function by clicking the jot note button (93). The jot function will convert the display panel (76) for jotting free hand drawing and hand written notes. System component (7) accepts electronic documents to be created by template forms or free hand drawings and writings using pointing devices such as pen mouse or tablet PC, to enable a user to enter intermediate summary report directly to the current node. Validation begins from the base node, and traverse down to its supporting facts recursively until transparency is reached.

Other embodiments and uses of the invention will be apparent to those skilled in the art from consideration of the specification and practice of the invention disclosed herein. The preferred embodiment and examples stated above should be considered exemplary only.

What is claimed is:

1. A semantic network management system in a document repository system comprising:
A computer system running as a client comprises of integrated dash board, a graphical user interface panel or panels that enables user to perform functions interactively to maintain a semantic network and associates documents to the nodes of the semantic network;
said integrated dashboard formulates network maintenance, document storage and retrieval requests to a server system that provides services to the request;
said server system manages a semantic network of any number of nodes and relations that connects nodes together for the purpose of storage and retrieval of documents that relates to the context of a semantic network node.

2. The semantic network management system of claim 1, wherein the user interfaces comprise at least one graphical user interface from a web browser, a desktop graphical interface, or an interface provided by a wireless device.

3. The semantic network management system of claim 1, wherein the semantic network nodes and relationships are used in the context of propositional logic for the specification of criteria.

4. The semantic network management system of claim 1, wherein the client and the server resides on the same computer system.

5. The semantic network management system of claim 1, wherein communication of the request from the client and the service provided by the server is not transmitted over a computer network.

6. The semantic network management system of claim 1, wherein the documents reference by a semantic network node is not physically stored in the same computer system.

7. The semantic network management system of claim 1, wherein the request generated by the client system is a procedure comprised of multiple steps of functions, and at least one of the steps comprises of functions defined in claim 1.

8. The semantic network management system of claim 1, wherein the client and the server are comprised of a single computer process.

9. The semantic network management system of claim 1, wherein documents shall include text files, image files, and multimedia files store as file in a computer system or as database objects in a database management system.
